(19) United States
(12) Patent Application Publication
(10) Pub. No.: US 2002/0179068 A1
(43) Pub. Date: Dec. 5, 2002

(54) Method of operating an internal -combustion engine

(76) Inventor: Stephan Mueller, Leonberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/149,972

(22) PCT Filed: Sep. 1, 2001
(86) PCT No.: PCT/EP01/10095

(30) Foreign Application Priority Data
Oct. 18, 2000 (DE) 10051674.2

(51) Int. Cl. F02M 25/07

(52) U.S. Cl. 123/568.21; 701/108

(57) ABSTRACT

The invention relates to a method of operating an internal-combustion engine having an exhaust gas recirculation, in which the exhaust gas discharge (12) is connected with the intake system (2) by way of an exhaust gas recirculation pipe (16), the exhaust gas recirculation rate being determined by means of an exhaust gas recirculation valve (18) arranged in the exhaust gas recirculation pipe by way of a desired characteristic diagram in which engine input quantities, such as the engine temperature, the load or the rotational engine speed are taken into account.

It is suggested that, for the determination of an adaptive exhaust gas recirculation rate (AGRadapt), a driving dynamics factor (Fd(t) is taken into account which can be determined corresponding to the driver's driving style or his traffic-situation-caused actions with respect to the control of the motor vehicle.

### BACKGROUND AND SUMMARY OF THE INVENTION

The invention relates to a method of operating an internal-combustion engine.

In the prior art, various measures are employed to improve exhaust gas quality. One of these measures is exhaust gas recirculation, in which a portion of the exhaust gas flow is returned to the fuel-air mixture in the intake system. As a result, the cylinders receive a smaller charge of the fuel-air mixture during the stoichiometric operation. Because the recirculated exhaust gas flow does not take part in combustion, the partial oxygen pressure and thus the combustion temperature are reduced. This results in an up to 60% reduction of nitrogen oxides during combustion. However, as the rate of exhaust gas recirculation increases, the content of unburnt hydrocarbon compounds and fuel consumption may also increase. These factors determine the upper limit of the exhaust gas recirculation rate. In conventional engines, the exhaust gas recirculation rate is controlled by an exhaust gas recirculation valve as a function of operating variables, such as engine temperature, load and rotational engine speed (see also Fachkunde Kraftfahrzeugtechnik (Technical Information: Automotive Engineering), 26th Edition, Europa-Lehrmittel Publishers, Page 311).

In the case of engines with direct gasoline injection, large quantities of recirculated exhaust gas are required in order to minimize as much as possible crude NOx emissions particularly in lean operation (λ>1). Especially in the case of engines having a large displacement volume, which correspondingly have a large intake volume, this demand leads to a target conflict with respect to performance readiness, because the complete suction system is partially filled with exhaust gas. In the case of transient operations, during which the engine has to be changed from a partial load range with exhaust gas recirculation to the full-load range without exhaust gas recirculation, several power cycles are required before the exhaust gas is evacuated from the suction system and the torque desired by the driver is therefore available. This operation causes a delayed response and therefore a loss of dynamics which results in an unpleasant feeling particularly in the case of sportscars.

It is therefore an object of the invention to solve this target conflict by developing a control process to reduce pollutant emission with recirculation of exhaust gas but without major losses of driving dynamics.

This object is achieved by the invention described hereinafter. As a result of an adaptive exhaust gas recirculation, during which the exhaust gas recirculation rate is controlled as a function of the driver's driving dynamics, the initially described target conflict is resolved. By quantifying the dynamic driving desire by means of a driving dynamics factor, a desired characteristic exhaust gas recirculation diagram filed in the control unit can be modulated such that, when the dynamics are low, the maximum desired exhaust gas recirculation is recirculated, and when the dynamics are high, there is no exhaust gas recirculation at all.

### BRIEF DESCRIPTION OF THE DRAWINGS

FIG. 1 shows the known schematic construction of an internal-combustion engine with exhaust gas recirculation;

FIG. 2 shows a desired characteristic diagram for the exhaust gas recirculation;

FIG. 3 shows a characteristic curve for determining an exhaust gas recirculation factor; and

FIG. 4 shows a schematic overall representation for determining an adaptive exhaust gas recirculation rate.

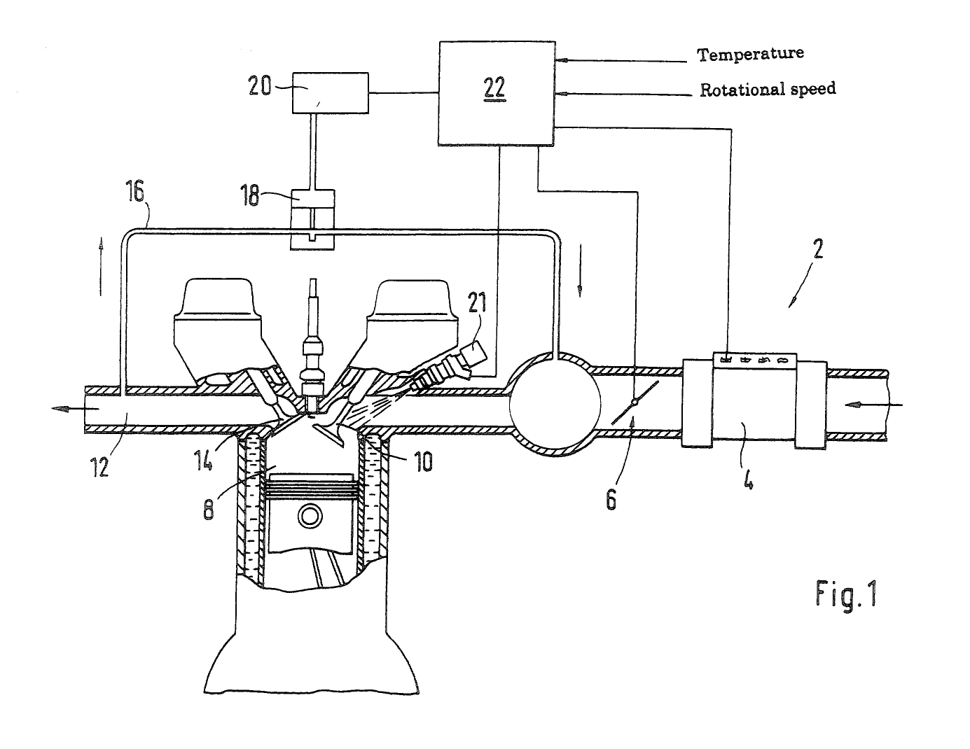

### DETAILED DESCRIPTION OF THE DRAWINGS

An air flow rate sensor 4 and a throttle valve 6 arranged downstream from the air flow rate sensor 4 in the flow direction are arranged in an air intake duct 2 of an internal-combustion engine. The air intake duct 2 leads into a cylinder space 8 to which combustion air is supplied as a function of the throttle valve position and the valve timing for an inlet valve 10. By way of an outlet duct 12, the exhaust gas is discharged by way of an outlet valve 14 controlling the flow to the outlet duct 12.

The air intake duct 2 and the outlet duct 12 are connected by way of an exhaust gas recirculation pipe 16. In the exhaust gas recirculation pipe 16, an exhaust gas recirculation valve 18 is arranged which controls the opening cross-section of the exhaust gas recirculation pipe 16 and which is controlled by way of an electro-pneumatic transducer 20. By way of an injector 21 arranged in the intake duct 2 near the inlet valve 10, fuel is injected. The fuel and combustion air is ignited as a fuel-air mixture in the combustion space. A control unit 22 is connected with, among other devices, the air flow rate sensor 4, the throttle valve 6, the electropneumatic transducer 20 and the injector 21.

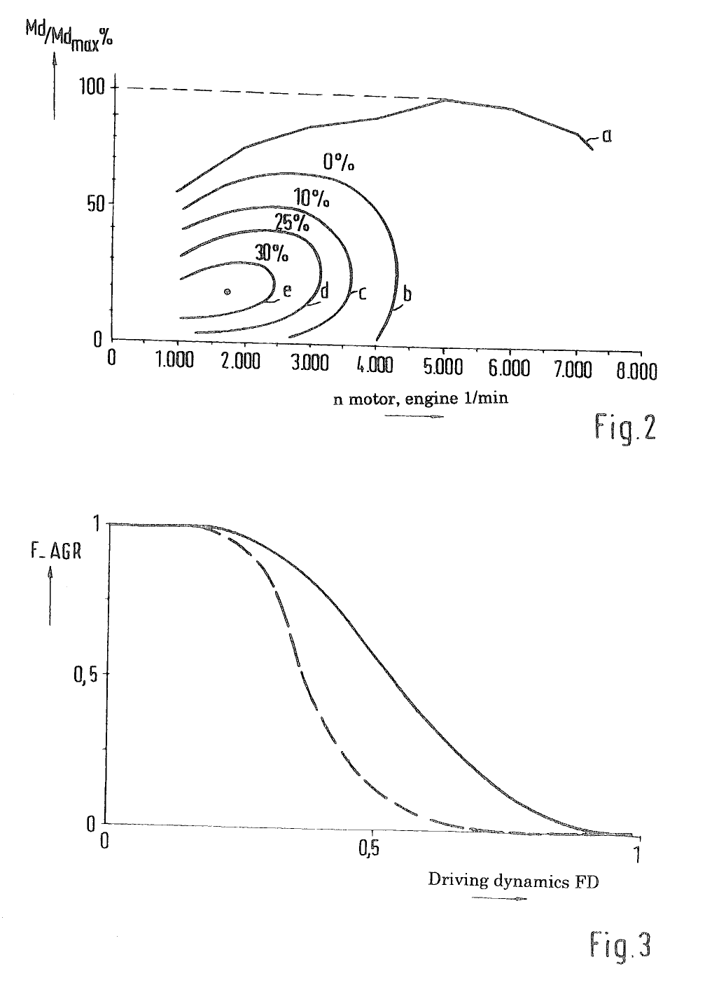

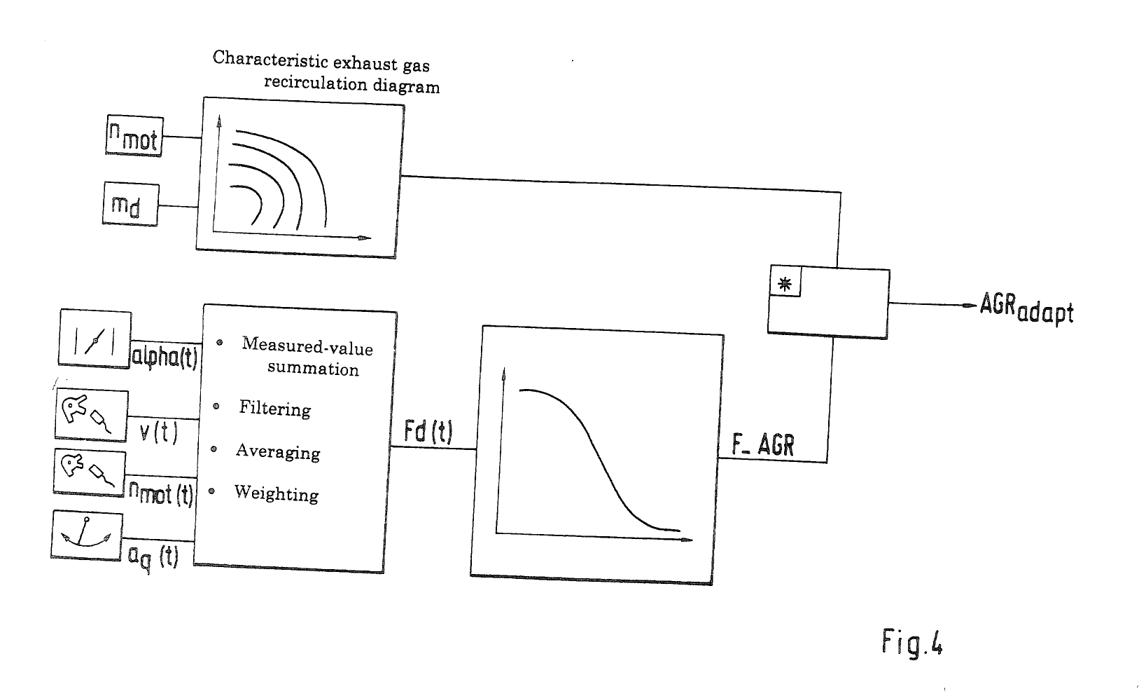

In the following, the adaptive control of the exhaust gas recirculation rate will be explained in detail. The control unit 22 has a characteristic exhaust gas recirculation diagram (hereinafter referred to as the desired characteristic exhaust gas recirculation diagram). The curve “a” illustrated in FIG. 2 represents the torque—boundary curve of the engine. Below the curve, continuous control of the exhaust gas recirculation rate takes place. The four curves “b” to “e” shown as examples represent curves of the same exhaust gas recirculation rates. In the full-load range when the torque required as a function of the rotational speed is above line “b”, no external exhaust gas recirculation takes place. When the required torque values are between curves “b” and “c”, the exhaust gas recirculation rate is continuously controlled between 0 and 10% of the overall exhaust gas flow rate. At torque values between curves “c” and “d”, the exhaust gas recirculation rate is between 10 and 25%, while, in the case of torque values between curves “d” and “e”, the exhaust gas recirculation rate rises to 30%. In the partial-load range of engines with direct gasoline injection (lean operation with stratified charging), the maximum exhaust gas recirculation rate may reach 40% for torque values within the curve “e”.

In addition to the desired characteristic exhaust gas recirculation diagram of the control unit 22, for the determination of an adaptive exhaust gas recirculation rate, driving dynamics Fd(t) are determined which depend on the driver's driving style or actions in reaction to driving conditions. For determining a driving dynamics factor, a functional relationship, assessed over a period of time, is established from cyclically or non-cyclically detected present and past values of a single operating parameter or a single quantity composed of several operating parameters of a motor vehicle. In the illustrated embodiment, for example, values of the throttle valve position α(t), of the vehicle speed v(t), of the lateral acceleration a_{q}(t) and of the engine speed nₘₒₜ(t) are determined in the second or millisecond range and additional values are computed therefrom, such as the rate of throttle valve change dα(d)/dt and the acceleration of the vehicle dv(t)/dt. The determined and computed values are linked by way of characteristic diagrams with additional operating parameters and are combined by way of a functional relationship to form an intermediate quantity. Using sliding averaging, which takes into account the newly computed values as well as the past values, the driving dynamics Fd(t) are determined from the intermediate quantity. An exhaust gas recirculation factor F_AGR is determined from a characteristic curve (see FIG. 3) in the control unit 22 with the driving dynamics factor Fd as the independent variable. The characteristic curve may be determined empirically. The value of each of the exhaust gas recirculation factor and the driving dynamics factor has a range between 0 to 1 in the illustrated embodiment. For the determination of the adaptive exhaust gas recirculation rate AGRadapt, the exhaust gas recirculation rate determined from the desired characteristic AGR diagram is multiplied by the exhaust gas recirculation factor F_AGR. Then, the control unit 22 sets the exhaust gas recirculation valve 18 by way of the electropneumatic transducer 20 in accordance with the determined adaptive exhaust gas recirculation rate AGRadapt. As illustrated by means of the broken characteristic curve in FIG. 3, the functional relationship between the driving dynamics factor Fd and the exhaust gas recirculation factor F_AGR can also be changed or adapted.

1. Method of operating an internal-combustion engine having an exhaust gas recirculation, in which the exhaust gas discharge is connected with the intake system by way of an exhaust gas recirculation pipe, the exhaust gas recirculation rate being determined by means of an exhaust gas recirculation valve arranged in the exhaust gas recirculation pipe by way of a desired characteristic diagram in which engine input quantities, such as the engine temperature, the load or the rotational engine speed are taken into account,
characterized in that, for the determination of an adaptive exhaust gas recirculation rate (AGRadapt), a driving dynamics factor (Fd(t) is taken into account which can be determined corresponding to the driver's driving style or his traffic-situation-caused actions with respect to the control of the motor vehicle.

2. Method according to claim 1,
characterized in that, by way of a characteristic curve filed in a control unit (22), an exhaust gas recirculation factor F_AGR is determined from the driving dynamics factor Fd(t), by means of which exhaust gas recirculation factor F_AGR, the exhaust gas recirculation rate is weighted which is determined from the desired characteristic diagram.

3. Method according to claim 1,
characterized in that the driving dynamics factor Fd(t) is determined by a functional relationship (sliding averaging) evaluating the driver's driving style or his traffic-situation-caused actions from cyclically or anticyclically detected actual and past values of a single operating parameter or a single quantity composed of several operating parameters of a motor vehicle.
